(19) United States
(12) Patent Application Publication
(10) Pub. No.: US 2012/0293916 A1
(43) Pub. Date: Nov. 22, 2012

(54) ELECTROLYTE SOLUTION FOR LITHIUM-ION CAPACITOR AND LITHIUM-ION CAPACITOR INCLUDING THE SAME

(75) Inventors: Sang Kyun LEE, Gyeonggi-do (KR); Hong Seok Min, Gyeonggi-do (KR); Bae Kyun Kim, Gyeonggi-do (KR); Ji Sung Cho, Gyeonggi-do (KR)

(73) Assignee: SAMSUNG ELECTRO-MECHANICS CO., LTD., Suwon (KR)

(21) Appl. No.: 13/456,912

(22) Filed: Apr. 26, 2012

(30) Foreign Application Priority Data
May 20, 2011 (KR) 10-2011-0047905

(51) Int. Cl. H01G 9/035

(52) U.S. Cl. 361/505; 252/62.2

(57) ABSTRACT

Disclosed herein are an electrolyte solution composition and an energy storage device including the same. The electrolyte solution may include: a solvent including one or more compound selected from one or more cyclic carbonate compound; and additives including one or more selected from a group consisting of catechol carbonate (CC), fluoro ethylene carbonate (FEC), propane sulton (PS), and propene sulton (PST).

### CROSS REFERENCE(S) TO RELATED APPLICATIONS

This application claims the benefit under 35 U.S.C. Section 119 of Korean Patent Application Serial No. 10-2011-0047905, entitled “Electrolyte. Solution For Lithium-Ion Capacitor And Lithium-Ion Capacitor Including The Same” filed on May 20, 2011, which is hereby incorporated by reference in its entirety into this application.

### BACKGROUND OF THE INVENTION

1. Technical Field

The present invention relates to an electrolyte solution composition and an energy storage device including the same.

2. Description of the Related Art

A stable supply of energy has been an important factor in various electronic products such as information communication devices. Generally, this function is performed by a capacitor. In other words, the capacitor serves to store and supply electricity in circuits of information communication devices and various electronic products, thereby stabilizing a flow of electricity in circuits. A general capacitor has a very short charging/discharging time, a long life span, and high output density, but has low energy density. Therefore, it has a limitation in being used as an energy storage device.

Meanwhile, a device referred to as an ultra capacitor or a super capacitor has been spotlighted as a next-generation storage device due to rapid charging/discharging speed, high stability, and environment-friendly characteristics. The general supercapacitor is configured to include an electrode structure, a separator, an electrolyte solution, or the like. The super capacitor is driven based on an electrochemical reaction mechanism that selectively adsorbs carrier ions in the electrolyte solution to the electrode by applying power to the electrode structure. An example of a representative supercapacitor may include an electric double layer capacitor (EDLC), a pseudocapacitor, a hybrid capacitor, or the like.

The electric double layer capacitor is a supercapacitor that uses an electrode made of activated carbons and uses an electric double layer charging as a reaction mechanism. The pseudocapacitor is a supercapacitor which uses a transition metal oxide or a conductive polymer as an electrode and uses pseudo-capacitance as a reaction mechanism. The hybrid capacitor is a supercapacitor having intermediate characteristics between the electric double layer capacitor and the pseudocapacitor.

As the hybrid capacitor, a lithium ion capacitor (LIC) which uses a cathode made of activated carbon and an anode made of graphite and uses lithium ions as carrier ions to have high energy density of a secondary battery and high output characteristics of the electric double layer capacitor has been spotlighted.

The lithium ion capacitor contacts negative electrode material capable of absorbing and separating the lithium ions to a lithium metal and absorbs or dopes the lithium ions in the negative electrode in advance using a chemical method or an electrochemical method, thereby lowering potential of the negative electrode to enlarge withstanding voltage and considerably improve energy density.

However, when the electrolyte solution used for the secondary battery according to the related art is applied to the lithium ion capacitor as it is, gas may be generated and reliability and performance may be degraded, due to continuous reaction of a carbon material used as an electrode material with the electrolyte solution.

### SUMMARY OF THE INVENTION

An object of the present invention is to provide an electrolyte solution for a lithium ion capacitor and a lithium ion capacitor including the same capable of improving reliability under high output charging/discharging conditions.

According to an exemplary embodiment of the present invention, there is provided an electrolyte solution for a lithium ion capacitor, including: a solvent including one or more compound selected from one or more cyclic carbonate compound; and additives including one or more selected from a group consisting of catechol carbonate (CC), fluoro ethylene carbonate (FEC), propane sulton (PS), and propene sulton (PST).

The electrolyte solution may further include a solute including one or more selected from a group consisting of LiPF6, LiBF4, LiSbF6, LiAsF5, LiClO4, LiN, CF3SO3, and LiC.

The solute may be LiPF6 of 1.0 mol/L to 1.5 mol/L.

The solvent may include ethylene carbonate (EC), propylene carbonate (PC), and ethyl methyl carbonate (EMC).

A weight ratio of the ethylene carbonate, the propylene carbonate, and the ethyl methyl carbonate may be 3±0.5:1±0.5:4±0.1.

A weight ratio of catechol carbonate to electrolyte solution may be 3 to 5wt % or less.

A weight ratio of fluoro ethylene carbonate to electrolyte solution may be 1 to 5wt % or less.

A weight ratio of propene sulton to electrolyte solution may be 1 to 5wt % or less.

A weight ratio of propane sulton to electrolyte solution may be 1 to 5wt % or less.

According to another exemplary embodiment of the present invention, there is provided a lithium ion capacitor, including: a case; an anode and a cathode disposed to be spaced from each other in the case; a separator partitioning the anode and the cathode in the case; and an electrolyte solution filled in the case, wherein the electrolyte solution is the above-mentioned electrolyte solution for the lithium ion capacitor.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, an electrolyte solution composition according to exemplary embodiments of the present invention will be described in detail.

The electrolyte solution composition according to exemplary embodiments of the present invention may include a solute, a solvent, and additives.

In this case, an example of the solute may include a lithium salt such as LiPF6, LiBF4, LiSbF6, LiAsF5, LiClO4, LiN, CF3SO3, and LiC, or the like.

In particular, among the lithium salts, LiPF6 of 1.0 mol/L to 1.5 mol/L may be used.

Meanwhile, the solvent forming the electrolyte solution composition according to the exemplary embodiment of the present invention may be made of a mixture of materials selected from cyclic carbonate compounds.

In particular, an example of the cyclic carbonate compounds may include ethylene carbonate (EC), propylene carbonate (PC), and ethyl methyl carbonate (EMC), or the like.

In this case, the weight ratio of the ethylene carbonate, the propylene carbonate, and the ethyl methyl carbonate may be 3±0.5 1:±0.5:4±0.1.

The additives may include one or more selected from a group consisting of catechol carbonate (CC), fluoro ethylene carbonate (FEC), propane sulton (PS), and propene sulton (PST)

The additives form solid electrolyte solution interphase (SEI) by reacting an electrode material earlier than other components of the electrolyte solution.

Therefore, gas generation may be reduced and reliability may be improved since the reaction of the solvent in the electrolyte solution and the electrode material can be reduced.

In this case, a weight ratio of catechol carbonate to electrolyte solution may be 5 wt % or less.

In addition, a weight ratio of fluoro ethylene carbonate to electrolyte solution may be 5 wt % or less.

In addition, a weight ratio of propane sulton to electrolyte solution may be 10 wt % or less.

In addition, a weight ratio of propene sulton to electrolyte solution may be 5 wt % or less.

### EXPERIMENTAL EXAMPLE

In order to analyze the electrolyte solution characteristics for the lithium ion capacitor, coating a current collector with activated carbon having a specific surface area of 2000 m2/g at a thickness of 60 μm was used as a cathode.

In addition, coating the current collector with hard carbon having a specific surface area of 10 m2/g at a thickness of 25 μm was used as an anode.

In addition, in the composition of the electrolyte solution, LiPF6 of 1.0˜1.5 mol/L was used as a solute and EC:PC:EMC=3±0.5:1±0.5:4±0.1 was used as a solvent.

In addition, the initial resistance and the capacity retention of the electrolyte solution were measured by adding each of the following material as the additives in the electrolyte solution.

In this case, the capacity retention means a ratio of capacity after acceleration experiment (100 C rate charging and discharging, 10,000 cycles) to initial capacity.

(Control group 1) not including additives

(Example 1) Catechol Carbonate (CC), 5 wt %

(Example 2) Fluoro Ethylene Carbonate (FEC), 5 wt %

(Example 3) Propane Sultone (PS), 10 wt %

(Example 4) Propene Sultone (PS), 5 wt %

For each example, as a result of measuring the initial resistance (Ω) and the capacity retention (%) under 25° and −40°, the results of the following Table could be obtained.

TABLE 1
Results of measuring product characteristics according to kind
of additives

| Division | Control 1 | Example 1 | Example 2 | Example 3 | Example 4 |
|---|---|---|---|---|---|
| Additives | Non-added | CC | FEC | PS | PST |
| Initial | 0.35 | 0.55 | 0.44 | 0.35 | 0.66 |
| Resistance | | | | | |
| (Ω) | | | | | |
| Capacity | 72 | 90 | 91 | 92 | 82 |
| Retention | | | | | |
| (%) | | | | | |

It can be appreciated from the above Table 1 that the lithium ion capacitor according to Example 1 to Example 4 slightly increases the initial resistance but significantly increases the capacity retention as compared with Control 1.

In this case, as the contents of the additives are increased, the capacity retention may be increased but the absolute amount of the lithium ion in the electrolyte solution of the lithium ion capacitor is reduced as much, thereby reducing the absolute capacity of the lithium ion capacitor.

In addition, as the contents of the additive are increased, the initial resistance is also increased, thereby having an adverse effect on the output characteristics.

Therefore, the content for each additive may be determined by comparing the increasing rate of the initial resistance, the reducing rate of the absolute capacity, and the increasing rate of the capacity retention. It was confirmed that the contents used in Example 1 to Example 4 are the optimal conditions.

Meanwhile, the lithium ion capacitor according to the exemplary embodiment of the present invention may be implemented by injecting the electrolyte solution for the lithium ion capacitor according to the exemplary embodiment of the present invention as the electrolyte solution into the general lithium ion capacitor including a case; an anode and a cathode disposed to be spaced from each other in the case; a separator partitioning the anode and the cathode in the case; and the electrolyte solution filled in the case.

As set forth above, the lithium ion capacitor according to the exemplary embodiment of the present invention can be used as the working electrolyte solution of the lithium ion capacitor and can be used even in the process of predoping the anode of the lithium ion capacitor with the lithium ions.

Further, the electrolyte solution for the lithium ion capacitor according to the exemplary embodiment of the present invention can efficiently perform the dissociation process of the solute, suppress the increase in viscosity of the electrolyte solution, and improve electric conductivity of the electrolyte solution.

In addition, the exemplary embodiment of the present invention can maintain normal temperature and low temperature characteristics of the electrolyte solution equally while providing excellent wettability for the electrode material.

Further, the exemplary embodiment of the present invention can improve the reliability of the high output lithium ion capacitor by selectively reacting the additives included in the electrolyte solution with the material included in the solvent earlier than the electrode material to form the appropriate SEI membrane.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

1. An electrolyte solution for a lithium ion capacitor, comprising:
a solvent including one or more compound selected from one or more cyclic carbonate compound; and
additives including one or more selected from a group consisting of catechol carbonate (CC), fluoro ethylene carbonate (FEC), propane sulton (PS), and propene sulton (PST).

2. The electrolyte solution according to claim 1, further comoprising a solute including one or more selected from a group consisting of LiPF6, LiBF4, LiSbF6, LiAsF5, LiClO4, LiN, CF3SO3, and LiC.

3. The electrolyte solution according to claim 2, wherein the solute is LiPF6 of 1.0 mol/L to 1.5 mol/L.

4. The electrolyte solution according to claim 1, wherein the solvent includes ethylene carbonate (EC), propylene carbonate (PC), and ethyl methyl carbonate (EMC).

5. The electrolyte solution according to claim 4, wherein a weight ratio of the ethylene carbonate, the propylene carbonate, and the ethyl methyl carbonate is 3±0.5:1±0.5:4±0.1.

6. The electrolyte solution according to claim 1, wherein a weight ratio of catechol carbonate to electrolyte solution is 5 wt % or less.

7. The electrolyte solution according to claim 1, wherein a weight ratio of fluoro ethylene carbonate to electrolyte solution is 5 wt % or less.

8. The electrolyte solution according to claim 1, wherein a weight ratio of propane sulton to electrolyte solution is 10 wt % or less.

9. The electrolyte solution according to claim 1, wherein a weight ratio of propene sulton to electrolyte solution is 5 wt % or less.

10. A lithium ion capacitor, comprising:
a case;
an anode and a cathode disposed to be spaced from each other in the case;
a separator partitioning the anode and the cathode in the case; and
an electrolyte solution filled in the case,
wherein the electrolyte solution is the electrolyte solution for the lithium ion capacitor according to claim 1.
